(19) United States
(12) Patent Application Publication
(10) Pub. No.: US 2012/0176599 A1
(43) Pub. Date: Jul. 12, 2012

(54) OPTICAL TRANSCEIVER

(75) Inventors: Lydia Lap Wai Leung, Hong Kong (HK); Raymond Kwan Wai To, New Territories (HK); Luis Ng, New Territories (HK)

(73) Assignee: Hong Kong Applied Science and Technology Research Institute Co. Ltd., Shatin (HK)

(21) Appl. No.: 13/423,100

(22) Filed: Mar. 16, 2012

(51) Int. Cl. G01N 21/59; H01S 4/00

(52) U.S. Cl. 356/39; 29/592.1

(57) ABSTRACT

The subject matter disclosed herein relates to an optical emitter-detector for physiological measurements.

### FIELD

The subject matter disclosed herein relates to an optical emitter-detector for physiological measurements.

### BACKGROUND

Pulse oximetry is a non-invasive diagnostic procedure for measuring the level of oxygen saturation in a patient's arterial blood. Pulse oximetry is based on a principle of passing light energy from light emitters of at least two wavelengths through a light-absorptive physiologic medium to a light detector. Measurement of reflected (or transmitted) emitted light, in response to light absorption of the medium, may be used to calculate an oxygen saturation level. Pulse oximeters may have two components including a sensor to attach to a patient's skin for acquiring signals, and a processing unit for processing acquired signals to determine arterial blood oxygen saturation and pulse rate. Unfortunately, accuracy of measurements of a pulse oximeter may be compromised by light that travels from light emitters to a light detector of the pulse oximeter, bypassing a physiologic medium.

### BRIEF DESCRIPTION OF THE DRAWINGS

Non-limiting and non-exhaustive embodiments will be described with reference to the following objects, wherein like reference numerals refer to like parts throughout the various objects unless otherwise specified.

FIG. 1 is a plot of light transmission and absorption of blood as a function of time, according to an embodiment.

FIG. 2 is a top view of a light transceiver module, according to an embodiment.

FIG. 3 is a cross-section view of a light transceiver module, according to an embodiment.

FIG. 4 is another cross-section view of a light transceiver module, according to an embodiment.

FIG. 5 is a cross-section view of a light transceiver module showing light rays, according to an embodiment.

FIG. 6 is a perspective view of a light transceiver module, according to an embodiment.

FIG. 7 is a flow diagram of a process to fabricate a light transceiver module, according to an embodiment.

FIG. 8 is a cross-section view of a light transceiver module, according to another embodiment.

FIG. 9 is a cross-section view of a light transceiver module, according to yet another embodiment.

FIG. 10 is a cross-section view of a light transceiver module, according to still another embodiment.

FIG. 11 is a cross-section view of a light transceiver module, according to still another embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

As used to describe such embodiments, terms “above”, “below”, “upper”, “lower”, and “side” describe positions relative to an optical axis of such a compact imaging module. In particular, “above” and “below” refer to positions along an optical axis, wherein “above” refers to one side of an element and “below” refers to an opposite side of the element. Relative to such an “above” and “below”, “side” refers to a side of an element that is displaced from an optical axis, such as the periphery of a lens, for example. Further, it is understood that such terms do not necessarily refer to a direction defined by gravity or any other particular orientation. Instead, such terms are merely used to identify one portion versus another portion. Accordingly, “upper” and “lower” may be equivalently interchanged with “top” and “bottom”, “first” and “second”, “right” and “left”, and so on.

Embodiments described herein include a light transceiver module (LTM) that may be used for pulse oximetry measurements. Of course, an LTM may be used for any of a number of applications, and need not be limited in use to pulse oximetry measurements. Claimed subject matter is similarly not so limited. An LTM may include one or more light emitters and one or more light detectors. The light emitters may emit light to be detected by the light detectors. In a particular application of an LTM, light emitters may emit light into a physiologic medium of a relatively thin portion of a patient's body (human or animal) so that a light detector may measure the light transmitted through the medium. Such a physiologic medium may comprise an epidermis, dermis, and pigmentation (e.g., skin), and arterial and venous blood, for example. Measured light transmission may be used to calculate oxygen saturation levels of blood in a medium. Unfortunately, accuracy of calculated oxygen saturation levels of a pulse oximeter may be compromised by light that travels from light emitters to a light detector of the pulse oximeter, bypassing a physiologic medium. Accordingly, in some embodiments, a physical structure of an LTM may comprise features to enable a reduction or at least partial elimination of light that bypasses a physiologic medium and travels from light emitters to a light detector. Such features may include, for example, a partition between or among light emitters and detectors, and an encapsulant to cover the light emitters and detectors. In particular, such an encapsulant has a concave-shaped surface to refract light that crosses the concave-shaped surface, as explained in detail below. In addition to a partition mentioned above, such light refraction may facilitate a reduction or at least partial elimination of light that bypasses a physiologic medium and travels from light emitters to a light detector.

The term “encapsulate” means to at least partially cover or surround with a material, which may be impervious to gases or liquids, while allowing light transmission through the material. Encapsulating an electronic component may provide physical or chemical protection to the component. For example, an encapsulant may prevent air or moisture from reaching an encapsulated component, but allow light to reach the component. An encapsulant may initially comprise a liquid that may readily conform to a shape of an object being encapsulated. After a time period, which may include a curing process of heating or exposure to ultraviolet light, the liquid encapsulant may become solid. Encapsulant may comprise any of a number of materials, such as silicone.

In some embodiments, an LTM may comprise at least one light emitter, at least one light detector, and a frame. An LTM may be incorporated in a pulse oximetry device. The at least one light emitter, the at least one light detector, and the frame may be disposed on a substrate. The at least one light emitter may comprise two light emitting diodes (LEDs) that emit light having different wavelengths, for example. The frame may comprise an electrically or thermally conducting metal, though claimed subject matter is not so limited. In an implementation, the frame may include a partition between the at least one light emitter and the at least one light detector. An encapsulant, which may comprise a transparent material, may cover or encapsulate the at least one light emitter and the at least one light detector, wherein surfaces of the encapsulant may have a shape that is at least partially concave. The at least partially concave shape of surfaces of the encapsulant may be formed in a process that utilizes surface tension between a liquid form of the encapsulant and the frame. Such a process may further control a volume of the encapsulant. For example, a frame may comprise a dam to at least partially retain a liquid form of encapsulant in a volume about the at least one light emitter and the at least one light detector. The frame may include a partition to block a line of sight between the at least one light emitter and the at least one light detector. Here, “line of sight” means a path that may be traveled by light. Accordingly, blocking a line of sight may facilitate blocking light travel along the line of sight, for example.

An at least partially concave shape of a surface of an encapsulant encapsulating at least one light emitter may converge light emitted by the at least one light emitter. Similarly, the at least partially concave shape of a surface of an encapsulant encapsulating at least one light detector may converge light traveling toward the at least one light detector.

In an implementation, connecting wires may connect electronic circuitry on a substrate to at least one light emitter and may connect the electronic circuitry to at least one light detector. Encapsulant may cover such connecting wires. A substrate may comprise a printed circuit board (PCB). A substrate may have a shape that is at least approximately flat. A level of encapsulant encapsulating at least one emitter and at least one detector may be below a top of a frame and above the at least one light emitter, the at least one light detector, and connecting wires. An encapsulant may have perimeters that are at least partially rectangular, as described below, though claimed subject matter is not so limited.

In other embodiments, an LTM may comprise at least one light emitter and at least one light detector on a substrate. The LTM may also comprise a frame on the substrate so as to form a first dam region for the at least one light emitter and a second dam region for the at least one light detector. Such first and second dam regions may be at least partially filled with an encapsulant having a surface having a shape that is at least partially concave. First and second dam regions may have perimeters having shapes that are at least partially rectangular, for example. Of course, such details of an LTM are merely examples, and claimed subject matter is not so limited. For example, a frame may be mounted on a substrate before mounting at least one light emitter and at least one light detector on the substrate.

In an embodiment, an LTM may be fabricated by mounting at least one light emitter and at least one light detector on a substrate, and mounting a frame on the substrate so as to form a first dam region for the at least one light emitter and to form a second dam region for the at least one light detector. Fabrication may continue by at least partially filling the first and second dam regions with an encapsulant to at least partially cover the at least one light emitter and the at least one light detector. A surface of the encapsulant in the first dam region and in the second dam region may have a shape that is at least partially concave, for example. In one implementation, fabrication of an LTM may include partially filling first and second dam regions with a liquid encapsulant, which may comprise a controlled volume of liquid encapsulant, so as to have a surface having a shape that is at least partially concave based, at least in part, on surface tension between or among the liquid encapsulant and one or more portions of a frame. Over a time span, such liquid encapsulant may harden to form a solid encapsulant. First dam region and second dam region may be partitioned apart from each other by a partition of a frame that blocks a line of sight between the at least one light emitter and the at least one light detector, as mentioned above. Of course, such details of a process to fabricate an LTM are merely examples, and claimed subject matter is not so limited.

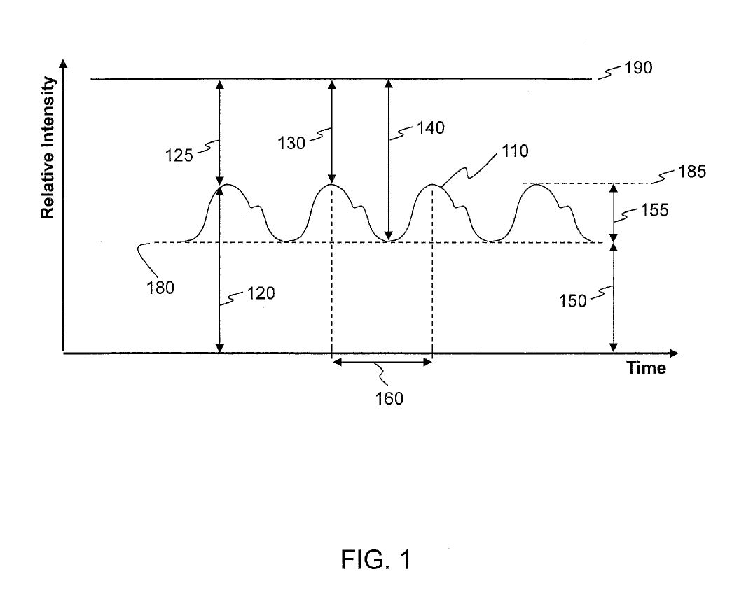

FIG. 1 is a plot of relative intensity of light transmission and absorption of a physiologic medium as a function of time for a pulse oximetry measurement, according to an embodiment. For example, in a particular application of an LTM, light emitters may emit light into a portion of a patient's fingertip so that a light detector may measure light transmitted or absorbed through the medium of the fingertip. As mentioned above, such a medium may comprise an epidermis, dermis, and pigmentation (e.g., skin), and arterial and venous blood, for example. Measured light transmission may be used to calculate oxygen saturation levels of blood in a medium. Line 190 indicates one-hundred percent transmission and zero absorption of emitted light detected by a detector. Curve 110 may comprise a transmission (or absorption) measurement at a particular wavelength of light for pulsating arterial blood and other elements in the medium. In particular, curve 110 may comprise a time-varying component having an absorption range 155 with a lower value indicated by element 180 and an upper value indicated by element 185. Curve 110 may also comprise a relatively steady-state component having an absorption range 150. Such a time-varying component may comprise a measurement of pulsating arterial blood. In contrast, such a relatively steady-state component may comprise a measurement of non-pulsating arterial blood, venous blood, or tissue (e.g., skin) of the medium. Element 160 indicates a time-span of a pulse of arterial blood based, at least in part, on a pulse rate of the patient, for example. Element 125 indicates transmitted light, whereas element 120 indicates absorbed light. Element 130 indicates an upper absorption value of curve 110, whereas element 140 indicates a lower absorption value of curve 110.

In pulse oximetry, a patient's blood oxygenation level may be determined by calculating a ratio of measured light absorption at a first wavelength to measured light absorption at a second wavelength. For example, measured light intensities at different wavelengths may be normalized before being compared to one another since intensities of different LEDs may be inconsistent with one another. Absorbing characteristics of DC components and sensitivity of a light detector may differ for two different wavelengths, and tissue absorption or path length may vary from patient to patient. A normalized signal may be calculated by dividing transmitted light intensities 125 by their individual peaks 140 of the corresponding wavelength. Absorbance of light may be derived by calculating the natural logarithm of measured and normalized transmitted light. A ratio R of normalized absorbance at red (A_{R}) and absorbance at infrared (A_{IR}) wavelengths may depend, at least in part, on light absorbers present in a patient's arterial blood: Ratio R=A_{R}/A_{IR}=ln(I_{L,R}/I_{H,R})/ln(I_{L,IR})I_{H,IR}), where I_{L,R} corresponds to element 140 of red light, I_{H,R} corresponds to element 130 of red light, I_{L,IR} corresponds to element 140 of IR light and I_{H,IR} corresponds to element 130 of IR light.

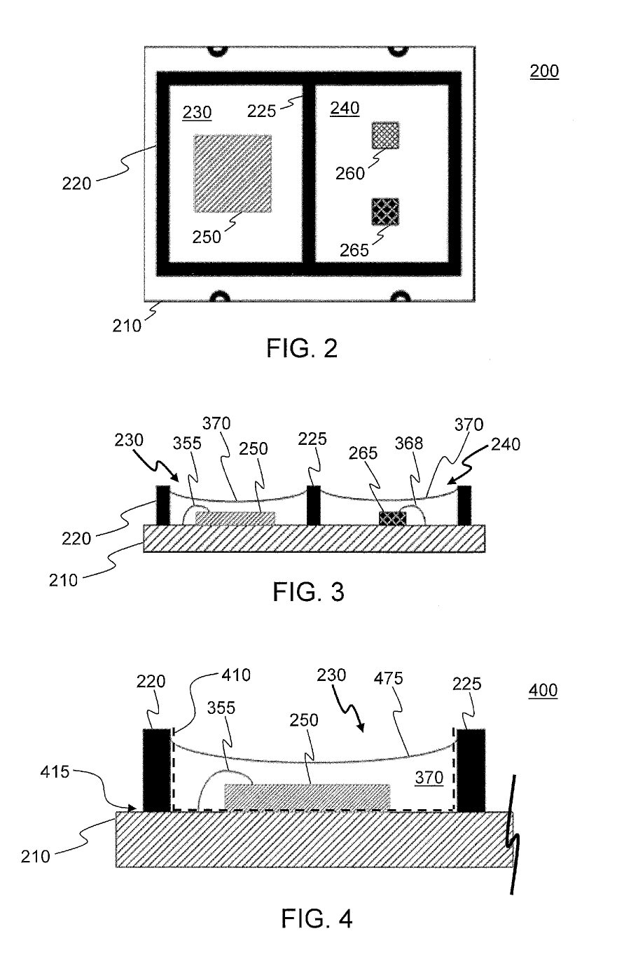

FIG. 2 is a top view and FIG. 3 is a cross-section view of an LTM 200, according to an embodiment. For example, LTM 200 may be incorporated in a pulse oximetry measuring device. LTM 200 may comprise light emitter 260 to emit light at a first wavelength and light emitter 265 to emit light at a second wavelength. Though LTM 200 is described as having two light emitters, in other embodiments an LTM may have any number of light emitters, and claimed subject matter is not limited in this respect. LTM 200 may comprise a light detector 250 to detect at least portions of light emitted from light emitters 260 and 265, for example. Light detector 250, and light emitters 260 and 265 may be disposed on a substrate 210. For example, substrate 210 may comprise a PCB that includes electronic circuitry to, among other things, operate light detector 250 and light emitters 260 and 265. In an implementation, connecting wires 355 and 368 may connect such electronic circuitry on substrate 210 to light detector 250 and light emitters 260 and 265, respectively.

LTM 200 may comprise a frame 220, which may comprise an electrically or thermally conducting metal, though claimed subject matter is not so limited. For example, an electrically conducting metal frame may facilitate electronic grounding, which may improve signal-to-noise ratios in pulse oximetry measurements. A thermally conducting metal frame May facilitate removal of heat from electronic components in LTM 200 and may transfer thermal heat from a finger of a patient to a temperature sensor connected to the metal frame for finger temperature measurements, for example. In an implementation, frame 220 may include a partition 225 to partition regions 240 and 230 that include light emitters 260, 265 and light detector 250, respectively. In an implementation, a physiologic medium may be measured by pulse oximetry incorporating LTM 200. In such a case, for example, partition 225 may enable a reduction or at least partial elimination of light that bypasses the physiologic medium and travels from light emitters 260, 265 to light detector 250. Frame 220 may be disposed on substrate 210 by any of a number of techniques. For example, frame 220 may be mounted to substrate 210 at least partially along a periphery of frame 220 using glue, epoxy, solder paste, or adhesive material. Frame 220 may be used during a process of fabricating LTM 200 to retain a liquid form of an encapsulant 370 in regions 230 and 240, as explained below. Accordingly, frame 220 may be mounted to substrate 210 so as to provide a seal between the frame and substrate to help avoid leakage of liquid encapsulant material to areas outside regions 230 and 240, for example.

Encapsulant 370, which may comprise an at least partially transparent material, may cover or encapsulate elements included in regions 230 and 240. In particular, encapsulant 370 may encapsulate light detector 250 and connecting wires 355 in region 230 and may encapsulate light emitters 260, 265, and connecting wires 368 in region 240, for example. In a process of encapsulating such elements in regions 230 and 240, a liquid form of encapsulant 370 may be deposited (e.g., poured) into regions 230 and 240 that may be surrounded by portions of frame 220 so as to create a dam around regions 230 and 240. Thus, for example, encapsulant 370 in liquid form may be poured into region 230 to cover light detector 250 and connecting wires 355. An amount of liquid encapsulant poured into region 230 may be sufficient to cover light detector 250 and connecting wires 355 while maintaining a level of encapsulant to be approximately less than a height of frame 220 (e.g., to avoid “spillover”).

In an embodiment, a liquid form of encapsulant 370 deposited (e.g., poured) into regions 230 and 240 surrounded by portions of frame 220 may attain a substantially or at least partially concave-shaped surface based, at least in part, on surface tension between encapsulant and frame 220. Surface tension between encapsulant and frame 220 may also help to control the volume of encapsulate poured into regions 230 and 240, for example. Subsequent to the liquid form of encapsulant 370 hardening to a solid form of encapsulant, concave-shaped surfaces of encapsulant 370 may retain this shape. A concave-shaped surface may refract light as the light crosses the concave-shaped surface. Accordingly, encapsulant 370 having a concave-shaped surface may have similar optical properties as that of a lens. In an implementation, a physiologic medium may be measured by pulse oximetry incorporating LTM 200. In such a case, for example, encapsulant 370 having a concave-shaped surface may enable a reduction of light that bypasses the physiologic medium and travels from light emitters 260, 265 to light detector 250. As explained below, light refracting across concave-shaped surfaces of encapsulant 370 may facilitate such a reduction of light “leakage”. Of course, such details of LTM 200 are merely examples, and claimed subject matter is not so limited.

FIG. 4 is a cross-section view of a portion 400 of light transceiver module 200 that includes light detector 250, according to an embodiment. LTM portion 400 may comprise a light detector 250 to detect at least portions of light emitted from light emitters 260 and 265, for example. Light detector 250 may be disposed on substrate 210. In an implementation, connecting wires 355 may connect electronic circuitry on substrate 210 to light detector 250. LTM portion 400 may comprise a frame 220, which may comprise an electrically or thermally conducting metal, though claimed subject matter is not so limited. In an implementation, frame 220 may include a partition 225 to partition a region 230 that includes light detector 250 (shown in FIG. 4) from a region that includes light emitters 260 and 265 (shown in FIG. 3). As mentioned above, by blocking a line of sight between emitter and detector, partition 225 may enable a reduction of light that bypasses a physiologic medium and travels from light emitters 260, 265 to light detector 250. Frame 220 may be disposed on substrate 210 by any of a number of techniques. For example, frame 220 may be mounted to substrate 210 at least partially along a periphery of frame 220 in interface regions 415 between frame 220 and substrate 210 using glue, epoxy, solder paste, or adhesive material. Frame 220 may be used during a process of fabricating LTM 200 to retain a liquid form of an encapsulant 370 in region 230 (and 240) within a boundary 410, indicated by dashed lines. Thus, a portion of substrate 210, a portion of frame 220, and partition 225 may work in conjunction with one another to form a dam to retain a liquid form of encapsulant material 370, for example. Accordingly, frame 220 (e.g., and partition 225) may be mounted to substrate 210 so as to avoid leakage of a liquid form of encapsulant 370 deposited into region 230. Such undesirable leakage may occur, for example, along interface regions 415.

As described above, a liquid form of encapsulant 370 deposited into region 230 may attain a substantially or at least partially concave-shaped surface 475 based, at least in part, on surface tension between encapsulant 370, a portion of frame 220, and partition 225. Subsequent to the liquid form of encapsulant 370 hardening to a solid form of encapsulant, concave-shaped surfaces of encapsulant 370 may retain this shape.

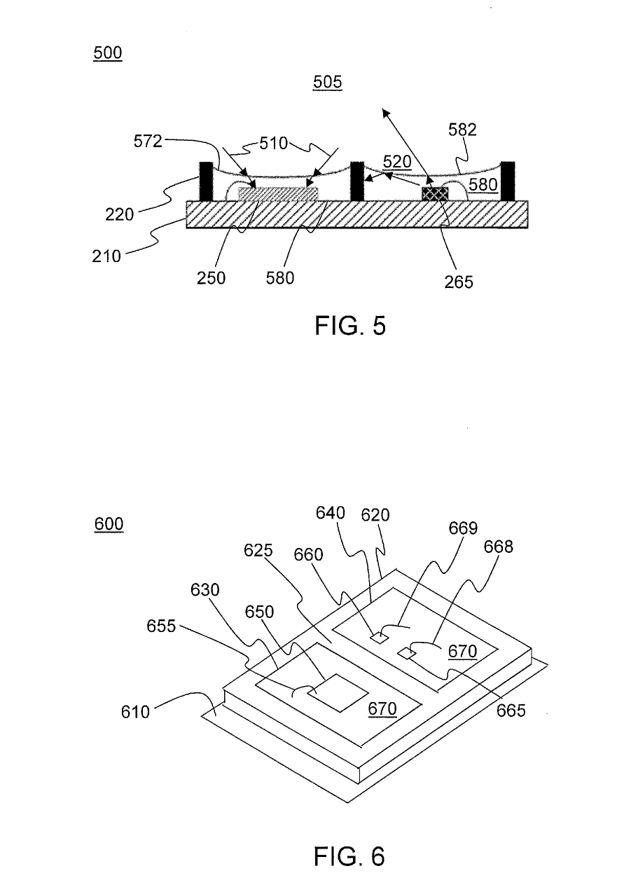

FIG. 5 is a cross-section view of a light transceiver module 500, according to an embodiment. LTM 500 may be similar to LTM 200, except that LTM 500 is shown with several light rays 520 depicting light emitted from light emitter 265 and several light rays 510 depicting light approaching light detector 250. In an embodiment, a liquid form of encapsulant 370 deposited (e.g., poured) into regions surrounded by portions of frame 220 may attain a substantially or at least partially concave-shaped surface based, at least in part, on surface tension between encapsulant and frame 220. Subsequent to the liquid form of encapsulant 370 hardening to a solid form of encapsulant, concave-shaped surfaces of encapsulant 370 may retain this shape. A concave-shaped surface may refract light as the light crosses the concave-shaped surface. Accordingly, encapsulant 370 having a concave-shaped surface may have similar optical properties as that of a lens. In particular, light emitted by light emitter 265 located within encapsulant 580 may refract upon exiting concave-shaped surface 582, which may comprise an optical “boundary” between encapsulant 580 having a first optical index of refraction and medium 505, such as air, having a second optical index of refraction. Such indices of refraction may be applied to Snell's Law, which may relate indices of refraction to angles of refraction at surface 582. Snell's law may be used to determine directions of light rays through refractive media with varying indices of refraction. Indices of refraction of the media may be used to represent a factor by which a light ray's angle changes. As light passes a boundary between media, depending at least in part upon the relative refractive indices of the two media, the light may either be refracted to a lesser angle, or a greater one. These angles may be measured with respect to a normal line, represented perpendicular to the boundary. If such a boundary is curved, such as in a concave shape, light traveling from one medium to another may converge or diverge, depending at least in part on direction of travel. For example, in a case of light traveling from encapsulant into air, light may be refracted away from the normal line to the (curved) boundary, whereas light traveling from air to encapsulant may refract towards the normal line. Also, light traveling from encapsulate to air may be “totally internally reflected” if the incident angle is larger than the critical angle for total internal reflection, though claimed subject matter is not limited in this respect.

Accordingly, in one embodiment, light emitted from light emitter 265 at a particular emitting angle may be total internally reflected in the encapsulant 580 and may not travel to light detector 250. On the other hand, light 510 approaching light detector 250 may be refracted to converging angles upon entering the concave-shaped surface of encapsulant 580. Such an arrangement of converging light from light emitter 265 and diverging light approaching light detector 250 may facilitate a reduction of “leakage” light that bypasses a physiologic medium and travels from light emitter 265 to light detector 250. One reason for such a reduction may be because leakage light, which may comprise light that bypasses (e.g., through medium 505) a physiologic medium, converges relatively rapidly compared to light that enters a physiologic medium. This may be so (e.g., referencing Snell's Law) if a physiologic medium has an index of refraction that is substantially close to that of encapsulant 580 compared to an index of refraction of medium 505. Such may be the case if medium 505 comprises air.

Relatively rapidly converging light bypassing a physiologic medium may travel a relatively short distance compared to light that enters the physiologic medium. Such a short travel distance of leakage light may be less than a travel distance needed to reach light detector 250. Accordingly, leakage light may desirably fall short of reaching light detector 250 while light that enters a physiologic medium may more easily reach the light detector.

Thus, leakage light emitted by light emitter 265 may converge so as to desirably fall short of reaching light detector 250. Such leakage light convergence may facilitate a reduction in the leakage light being received or detected by light detector 250. In an embodiment, concave-shaped surface 572 of encapsulant 580 above light detector 250 may further facilitate a reduction in the leakage light being received or detected by light detector 250. For example, concave-shaped surface 572 may redirect incoming light 510 to diverging angles so that at least a portion of light 510 may not impinge on light detector 250. Of course, such details light refraction and light leakage of an LTM are merely examples, and claimed subject matter is not so limited.

FIG. 6 is a perspective view of a light transceiver module 600, according to an embodiment. LTM 600 may be similar to LTM 200. LTM 600 may comprise light emitter 660 to emit light at a first wavelength and light emitter 665 to emit light at a second wavelength. Though LTM 600 is described as having two light emitters, in other embodiments an LTM may have any number of light emitters, and claimed subject matter is not limited in this respect. LTM 600 may comprise a light detector 650 to detect at least portions of light emitted from light emitters 660 and 665, for example. Light detector 650, and light emitters 660 and 665 may be disposed on a substrate 610. For example, substrate 610 may comprise a PCB that includes electronic circuitry to, among other things, operate light detector 650 and light emitters 660 and 665. In an implementation, connecting wires 655, 668, and 669 may connect such electronic circuitry on substrate 610 to light detector 650 and light emitters 660 and 665, respectively.

LTM 600 may comprise a frame 620, which may comprise an electrically or thermally conducting metal, though claimed subject matter is not so limited. In an implementation, frame 620 may include a partition 625 to partition regions 640 and 630 that include light emitters 660, 665 and light detector 650, respectively. Encapsulant 370, which may comprise an at least partially transparent material, may cover or encapsulate elements included in regions 630 and 640. In particular, encapsulant 670 may encapsulate light detector 650 and connecting wires 655 in region 630 and may encapsulate light emitters 660, 665, and connecting wires 668 and 669 in region 640, for example.

In an embodiment, a liquid form of encapsulant 670 deposited (e.g., poured) into regions 630 and 640 surrounded by portions of frame 620 may attain a substantially or at least partially concave-shaped surface based, at least in part, on surface tension between encapsulant 670 and frame 620. Subsequent to the liquid form of encapsulant 670 hardening to a solid form of encapsulant, concave-shaped surfaces of encapsulant 370 may retain this shape. A concave-shaped surface may refract light as the light crosses the concave-shaped surface. Accordingly, encapsulant 670 having a concave-shaped surface may have similar optical properties as that of a lens. Encapsulant 670 may have perimeters that are at least partially rectangular, substantially following an outline of frame 620 and partition 625, for example. Thus, concave-shaped surfaces of encapsulant 670 in regions 630 and 640 may have a square-shaped outline, a rectangular-shaped outline, or an outline having a portion that is linear, for example, though any portion of frame 620 need not be rectangular or linear.

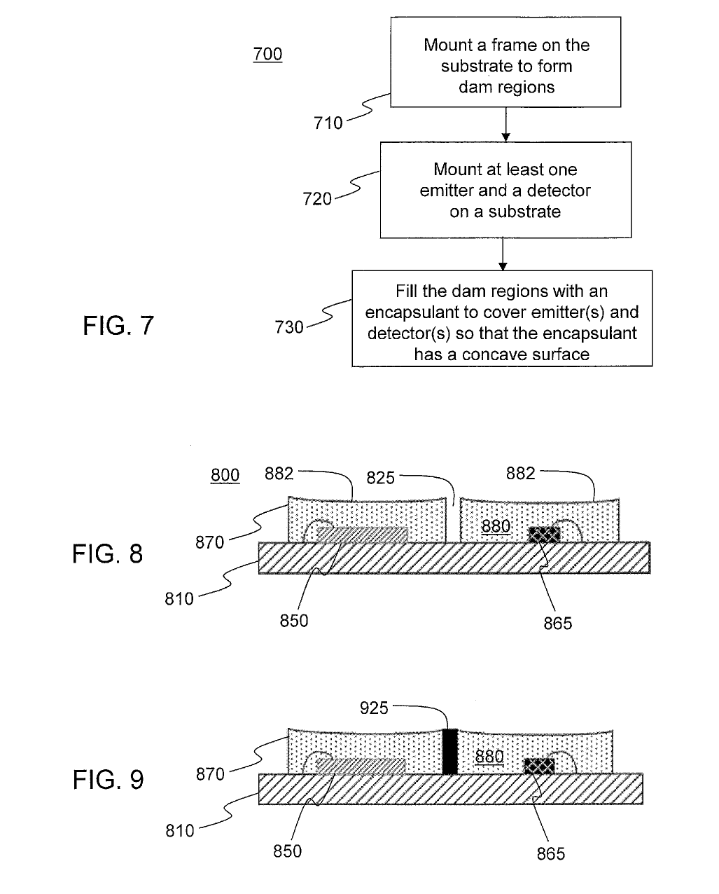

FIG. 7 is a flow diagram of a process 700 to fabricate a light transceiver module, according to an embodiment. At block 710, a frame may be mounted on the substrate so as to form a first dam region for the at least one light emitter and to form a second dam region for the at least one light detector. At block 720, an LTM may be fabricated by mounting at least one light emitter and at least one light detector on a substrate. At block 730, fabrication may continue by at least partially filling the first and second dam regions with an encapsulant to at least partially cover the at least one light emitter and the at least one light detector. A surface of the encapsulant in the first dam region and in the second dam region may have a shape that is at least partially concave, for example. In one implementation, fabrication of an LTM may include partially filling first and second dam regions with a liquid encapsulant so as to have a surface having a shape that is at least partially concave based, at least in part, on surface tension between or among the liquid encapsulant and one or more portions of a frame. Such liquid encapsulant may harden to form a solid encapsulant. First dam region and second dam region may be partitioned apart from each other by a partition of the frame. Such a partition may block a line of sight between the at least one light emitter and the at least one light detector, as mentioned above. Of course, such details of process 700 to fabricate an LTM are merely examples, and claimed subject matter is not so limited.

FIGS. 8 and 9 are cross-section views of a light transceiver module 800, according to another embodiment. LTM 800 may be similar to LTM 200, except that LTM 800 need not include a frame, such as frame 220, for example. In place of a partition such as 225, a gap 825 (e.g., an air gap) may intervene between encapsulant portion 870 and encapsulant portion 880.

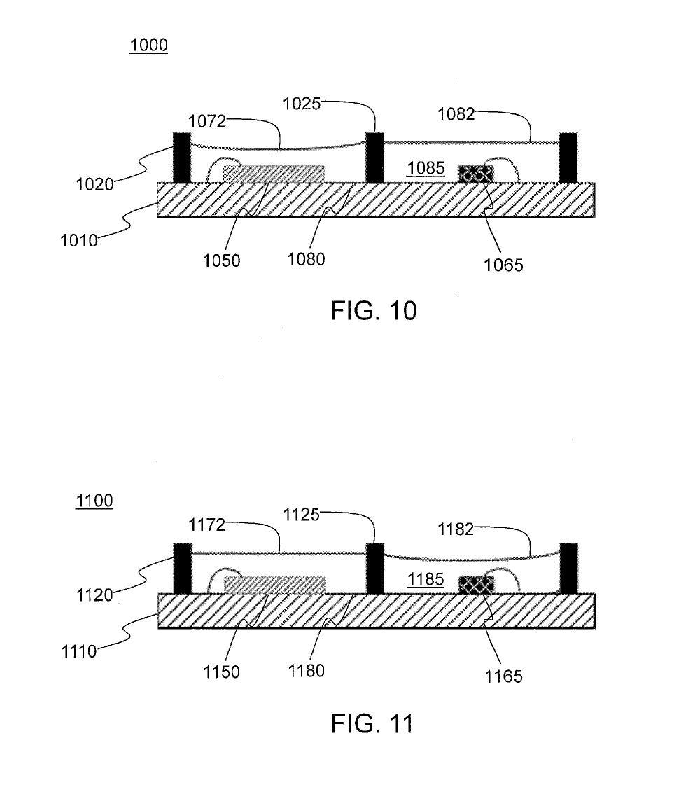

In an embodiment, a liquid form of encapsulant portion 870 and encapsulant portion 880 may be deposited to at least partially encapsulate a detector 850 and an emitter 865, respectively. Upon or after solidifying, solid forms of encapsulant portion 870 and encapsulant portion 880 may be shaped by any of a number of molding processes, such as a tooling process, injection molding process, just to name a few examples. Such a molding process may include forming encapsulant portions 870 and 880 so as to have a substantially or at least partially concave-shaped surface 882. Though not shown in FIG. 8 or 9, one of encapsulant portions 870 and 880 need not include such a concave-shaped surface (see embodiments shown in FIG. 10 or 11, for example). Such formed encapsulant portions 870 and 880 may be subsequently placed on a substrate 810. In a subsequent process, gap 825 may be at least partially filled with a conductive or non-conductive material 925 to block light emitted from emitter 865 from reaching detector 850, for example. Of course, such details of LTM 800 are merely examples, and claimed subject matter is not so limited.

FIG. 10 is a cross-section view of a light transceiver module 1000, according to still another embodiment. For example, LTM 1000 may be similar to LTM 200, except that one portion of encapsulant 1085 may have a substantially flat surface 1072 while another portion of encapsulant 1072 may have a substantially or at least partially concave-shaped surface 1082. Portion of encapsulant 1080 may include a detector 1050 mounted on a substrate and portion of encapsulant 1085 may include emitters 1065 also mounted on substrate 1010. LTM 1000 may comprise a frame 1020, which may comprise an electrically or thermally conducting metal, though claimed subject matter is not so limited. For example, an electrically conducting metal frame may facilitate electronic grounding, which may improve signal-to-noise ratios in pulse oximetry measurements. A thermally conducting metal frame may facilitate removal of heat from electronic components in LTM 200 and may transfer thermal heat from a finger of a patient to a temperature sensor connected to the metal frame for finger temperature measurements, for example. In an implementation, frame 1020 may include a partition 1025 to partition portions 1085 and 1080 that include light emitters 1065 and light detector 1050, respectively. A concave-shaped surface 1072 may refract light as the light crosses the concave-shaped surface. Accordingly, encapsulant 1080 having a concave-shaped surface may have similar optical properties as that of a lens. As explained above, light refracting across a concave-shaped surface 1072 of encapsulant 1080 may facilitate such a reduction of light “leakage”. Of course, such details of LTM 1000 are merely examples, and claimed subject matter is not so limited.

FIG. 11 is a cross-section view of a light transceiver module 1100, according to still another embodiment. For example, LTM 1100 may be similar to LTM 1000, except that a portion of encapsulant 1185 that includes light emitters 1165 may have a substantially or at least partially concave-shaped surface 1182 while portion of encapsulant 1172 including a detector 1150 may have a substantially flat surface 1172. Detector 1150 and emitters 1165 may be mounted on substrate 1110. LTM 1100 may comprise a frame 1120, which may comprise an electrically or thermally conducting metal, though claimed subject matter is not so limited. In an implementation, frame 1120 may include a partition 1125 to partition portions 1185 and 1180 that include light emitters 1165 and light detector 1150, respectively. A concave-shaped surface 1182 may refract light as the light crosses the concave-shaped surface. Accordingly, encapsulant 1185 having a concave-shaped surface may have similar optical properties as that of a lens. As explained above, light refracting across a concave-shaped surface 1182 of encapsulant 1185 may facilitate such a reduction of light “leakage”. Of course, such details of LTM 1100 are merely examples, and claimed subject matter is not so limited.

One skilled in the art will realize that a virtually unlimited number of variations to the above descriptions is possible, and that the examples and the accompanying figures are merely to illustrate one or more particular implementations.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. An apparatus comprising:
at least one light emitter, at least one light detector, and a frame, wherein said at least one light emitter, said at least one light detector, and said frame are disposed on a substrate; and
encapsulant portions to cover said at least one light emitter and said at least one light detector, wherein a surface of one or more of said encapsulant portions have a shape that is at least partially concave.

2. The apparatus of claim 1, further comprising connecting wires between said substrate and said at least one light emitter and between said substrate and said at least one light detector, wherein said encapsulant portions cover said connecting wires.

3. The apparatus of claim 1, wherein said at least partially concave shape of said surfaces of said encapsulant portions is formed by surface tension between a liquid form of said encapsulant portions and said frame.

4. The apparatus of claim 1, wherein said frame includes a partition between said at least one light emitter and said at least one light detector, and wherein said partition of said frame blocks a line of sight between said at least one light emitter and said at least one light detector.

5. The apparatus of claim 1, wherein said frame comprises an electrically and thermally conducting metal.

6. The apparatus of claim 1, wherein said frame comprises a dam for a liquid form of said encapsulant portions.

7. The apparatus of claim 1, wherein said at least one light emitter comprises two light emitting diodes (LEDs) that emit light having different wavelengths.

8. The apparatus of claim 1, wherein said substrate comprises a printed circuit board (PCB).

9. The apparatus of claim 1, wherein said encapsulant portions comprise a transparent material.

10. The apparatus of claim 1, wherein said substrate has a shape that is at least approximately flat.

11. The apparatus of claim 1, wherein a level of said encapsulant portions is below a top of said frame and above said at least one light emitter, said at least one light detector, and said connecting wires.

12. The apparatus of claim 1, wherein said at least partially concave shape of said surface of said encapsulant portion encapsulating said at least one light emitter converges light emitted by said at least one light emitter.

13. The apparatus of claim 1, wherein said encapsulant portions have perimeters that are at least partially rectangular.

14. The apparatus of claim 1, wherein said apparatus is incorporated in a pulse oximetry device.

15. A method comprising:
mounting at least one light emitter and at least one light detector on a substrate;
mounting a frame on said substrate so as to form a first dam region for said at least one light emitter and to form a second dam region for said at least one light detector; and
at least partially filling said first and second dam regions with an encapsulant to at least partially cover said at least one light emitter and said at least one light detector, wherein a surface of said encapsulant in said first dam region and in said second dam region has a shape that is at least partially concave.

16. The method of claim 15, wherein said at least partially filling said first and second dam regions with an encapsulant further comprises:
partially filling said first and second dam regions with a liquid encapsulant so as to have a surface having a shape that is at least partially concave based, at least in part, on surface tension between or among said liquid encapsulant and one or more portions of said frame.

17. The method of claim 16, further comprising:
providing a time span to allow said liquid encapsulant to harden to form said encapsulant.

18. The method of claim 15, wherein said first dam region and said second dam region are partitioned apart from each other by a partition of said frame that blocks a line of sight between said at least one light emitter and said at least one light detector.

19. An apparatus comprising:
at least one light emitter and at least one light detector on a substrate;
a frame on said substrate so as to form a first dam region for said at least one light emitter and a second dam region for said at least one light detector, wherein said first and second dam regions are at least partially filled with an encapsulant having a surface having a shape that is at least partially concave.

20. The apparatus of claim 19, wherein said first and second dam regions have perimeters having shapes that are at least partially rectangular.

21. An apparatus comprising:
at least one light emitter and at least one light detector on a substrate; and
a first encapsulant portion to cover said at least one light emitter and a second encapsulant portion to cover said at least one light detector, wherein a surface of at least one of said first and second encapsulant portions has a shape that is at least partially concave.

22. The apparatus of claim 21, further comprising a partition between said first and second encapsulant portions to block a line of sight between said at least one light emitter and said at least one light detector.

23. The apparatus of claim 21, further comprising a frame on said substrate to border said first and second encapsulant portions.
